(19) United States
(12) Patent Application Publication
(10) Pub. No.: US 2023/0169451 A1
(43) Pub. Date: Jun. 1, 2023

(54) SYSTEM AND METHOD OF PREDICTING A LAST MILE DESIGN PRODUCTIVITY OF A DELIVERY HUB

(71) Applicant: FLIPKART INTERNET PRIVATE LIMITED, Bengaluru (IN)

(72) Inventors: Vasudha Dhwan, New Delhi (IN); Shailendra Kumar, Bangalore (IN); Sanjay Kumar Kukreja, Bangalore (IN); Sumit Jindal, Sisra Haryana (IN)

(73) Assignee: FLIPKART INTERNET PRIVATE LIMITED, Bengaluru (IN)

(21) Appl. No.: 17/987,087

(22) Filed: Nov. 15, 2022

(30) Foreign Application Priority Data
Nov. 30, 2021 (IN) 202141055428

(51) Int. Cl. G06Q 10/0835

(52) U.S. Cl. CPC G06Q 10/08355

(57) ABSTRACT

A system and method of predicting a last mile design productivity of a delivery hub. The method comprises predicting: an inter-shipment time for last mile agent(s) of the delivery hub, and a productive on field time in a day for the last mile agent(s). The method thereafter encompasses predicting, a total number of delivery attempts in a day for the last mile agent(s) based on: the predicted inter-shipment time and the predicted productive on field time. Further, the method comprises predicting, a total number of successful deliveries in a day for the last mile agent(s) based on: the predicted total number of delivery attempts in a day, and an average hub conversion data. The method further comprises predicting the last mile design productivity of the delivery hub based on the predicted total number of successful deliveries in a day.

### RELATED APPLICATION

This application claims priority under 35 U.S.C. § 119 to Indian Patent Application No. 202141055428, filed on Nov. 30, 2021, the entire contents of which are incorporated herein by reference

### TECHNICAL FIELD

The present invention generally relates to productivity analysis and more particularly to systems and methods of predicting a last mile design productivity of a delivery hub for a target time period.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Supply chain management plays an important role in e-commerce. More particularly, a last mile network is the most important part of an e-commerce platform's supply chain, as it is the only part of the supply chain that directly interacts with customers of the e-commerce platform (for delivering shipments and picking up customer returns). Also, it is the most expensive leg of the supply chain owing to its asset and manpower heavy nature. Generally, an e-commerce platform may have thousands of delivery boys/last mile agents (LMAs) who deliver Lacs of shipments a day across a country while covering every route/corner of the country. Also, with increasing e-commerce adoption and given the importance of last mile (LM) in customer experience and cost, it is imperative that the LM network be optimally designed to maximize customer experience and minimize cost.

For a given time period, manpower to be planned for each delivery hub is completely dependent on design productivity and the demand expected in that delivery hub. To plan the headcount of delivery boys required to deliver shipments every day, it is required to understand the capacity of each delivery boy. More specifically, in order to understand the current state a comprehensive detailed view of a delivery hub productivity and delivery agent productivity is also required. In order to estimate the delivery hub productivity and the delivery agent productivity various solutions have been developed, but these are mostly manual processes which is predominantly negotiation-driven. As a result, justification for productivity increments is difficult as these are purely demand driven. Also, with one design productivity set for all delivery hubs, the currently known solutions end up having some delivery hubs which are highly under-utilized as opposed to some delivery hubs which are highly over utilized while comparing their actual productivity and design productivity. For instance, based on the currently known productivity estimation solutions some delivery hubs which have a potential of say 80 productivity get extra manpower while some delivery hubs which have potential of say 40 productivity end up with lesser manpower and stress situation in the delivery hub. Furthermore, in currently known solutions influence of factors other than demand such as stem distance, COD-Prepaid ratio and call duration etc. are also not considered. Currently, there is no scientific way to determine productivity sensitivity w.r.t to dependent variables. The currently known solutions also failed to determine an upper limit for productivity. Currently, a huge manpower is required to spend at least 5-7 days every month on negotiations.

Although a number of supply chain solutions have been developed to enhance nearly all major e-commerce operations and distribution processes, but the current estimation of capacity is very basic and has a lot of scope of improvement. Hence, there are a number of limitations of the current solutions and there is a need in the art to provide a method and system of predicting a last mile design productivity of a delivery hub for a target time period.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system of predicting a last mile design productivity of a delivery hub for a target time period. Another object of the present invention is to provide an efficient and effective solution for last mile delivery boy design productivity prediction in a supply chain.

Also an object of the present invention is to provide a solution that helps in solving estimation of more realistic monthly design productivity of each delivery hub. Further an object of the present invention is to design productivity prediction based on various factors such as stem distance, COD-Prepaid ratio and call duration etc. Another object of the present invention is to provide a solution that predicts more realistic design productivity for each delivery hub considering the type of routes the delivery hub services and capturing the historical trend of how the route density changes with change in demand of the hub. Also, an object of the present invention is to provide a more scientific way to determine productivity sensitivity w.r.t to the dependent variables. Further, an object of the present invention is to determine an upper limit for productivity. Another object of the present invention is to reduce a time spent on negotiations every month for productivity estimations. Yet another object of the present invention is to provide a solution that can easily simulate impact on design productivity with changes in different input parameters in different situations.

Furthermore, in order to achieve the aforementioned objectives, the present invention provides a method and system of predicting a last mile design productivity of a delivery hub for a target time period.

A first aspect of the present invention relates to the method of predicting a last mile design productivity of a delivery hub for a target time period. The method comprises receiving, at a transceiver unit, an estimated load to be allocated to the delivery hub for the target time period. The method thereafter comprises predicting, by a processing unit, an inter-shipment time for one or more last mile agents of the delivery hub based on the estimated load. Further the method leads to predicting, by the processing unit, a productive on field time in a day for the one or more last mile agents of the delivery hub. The method thereafter encompasses predicting, by the processing unit, a total number of delivery attempts in a day for the one or more last mile agents of the delivery hub based on: the predicted inter-shipment time for the one or more last mile agents of the delivery hub, and the predicted productive on field time in a day for the one or more last mile agents of the delivery hub. Further, the method comprises predicting, by the processing unit, a total number of successful deliveries in a day for the one or more last mile agents of the delivery hub based on: the predicted total number of delivery attempts in a day for the one or more last mile agents of the delivery hub, and an average hub conversion data, wherein the average hub conversion data is determined based on a second dataset. The method further comprises predicting, by the processing unit, the last mile design productivity of the delivery hub for the target time period based on the predicted total number of successful deliveries in a day for the one or more last mile agents of the delivery hub.

Another aspect of the present invention relates to a system of predicting a last mile design productivity of a delivery hub for a target time period. The system comprises a transceiver unit, configured to receive, an estimated load to be allocated to the delivery hub for the target time period. The system also comprises a processing unit, configured to predict an inter-shipment time for one or more last mile agents of the delivery hub based on the estimated load. The processing unit is also configured to predict a productive on field time in a day for the one or more last mile agents of the delivery hub. The processing unit is further configured to predict a total number of delivery attempts in a day for the one or more last mile agents of the delivery hub based on: the predicted inter-shipment time for the one or more last mile agents of the delivery hub, and the predicted productive on field time in a day for the one or more last mile agents of the delivery hub. Further, the processing unit is configured to predict a total number of successful deliveries in a day for the one or more last mile agents of the delivery hub based on: the predicted total number of delivery attempts in a day for the one or more last mile agents of the delivery hub, and an average hub conversion data, wherein the average hub conversion data is determined based on a second dataset. The processing unit is thereafter configured to predict the last mile design productivity of the delivery hub for the target time period based on the predicted total number of successful deliveries in a day for the one or more last mile agents of the delivery hub.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for predicting a last mile design productivity of a delivery hub for a target time period, in accordance with exemplary embodiments of the present invention.

FIG. 2 illustrates an exemplary method flow diagram [200] of predicting a last mile design productivity of a delivery hub for a target time period, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a processing unit, a transceiver unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section, existing technologies have many limitations and in order to overcome at least some of the limitations of the prior known solutions, the present disclosure provides a solution for predicting a last mile design productivity of a delivery hub for a target time period. More specifically, the present disclosure provides a more scientific way of approaching the problem where it first captures how each delivery hub's change in demand impacts a route density and a time required to attempt each shipment. This process correctly captures the route characteristics that each delivery hub services to come up with a more realistic design productivity for the delivery hub which the current way of working is not able to handle. For example: One delivery boy A has a route which has one tech park. The delivery boy will sit in front of one of the buildings and call the customers to come and pick up the shipment from him. In this case the delivery boy has no travel time. He just needs to sit at one place and wait for the customers vs a delivery boy B who goes to a residential area door to door where travel time between the customers consumes a significant amount of time. In this case delivery boy A may have a productivity of 100 vs delivery boy B who will have a productivity of 40. The present invention therefore provides a solution that captures how each delivery hub's change in demand impacts the route density and the time required to attempt each shipment.

More specifically, to predict the last mile design productivity of a delivery hub, the present disclosure provides a solution that first identifies an inter-shipment time for last mile agent(s) of the delivery hub based on an estimated number of shipments to be delivered by the delivery hub in a target time period. Further, the present solution encompasses predicting a productive on field time in a day for the last mile agent(s) of the delivery hub. The present solution thereafter encompasses predicting a total number of delivery attempts in a day for the last mile agent(s) of the delivery hub based on the predicted inter-shipment time and the predicted productive on field time in a day. Thereafter, a total number of successful deliveries in a day for the last mile agent(s) of the delivery hub is predicted based on the predicted total number of delivery attempts in a day and an average hub conversion data. Once, the total number of successful deliveries in a day for the last mile agent(s) of the delivery hub is predicted, the present invention encompasses predicting the last mile design productivity of the delivery hub based on the predicted total number of successful deliveries in a day for the last mile agent(s) of the delivery hub.

Therefore, the present invention provides a novel solution of predicting a last mile design productivity of a delivery hub for a target time period. The present invention provides a technical effect at least by providing a solution that can easily simulate impact on design productivity with changes in different input parameters in different situations. The present invention also provides a technical advancement over the currently known solutions by providing an efficient and effective automatic solution for last mile delivery boy design productivity prediction in a supply chain. Also, the present invention provides a technical advancement over the currently known solutions by estimating more realistic design productivity of each delivery hub. Furthermore, the present invention also provides a technical advancement over the currently known solutions by designing a productivity prediction based on various factors such as stem distance, COD-Prepaid ratio and call duration etc. The present solution is also technically advance over the currently known solutions as it provides an automatic solution that predicts more realistic design productivity for each delivery hub considering the type of routes the delivery hub services and capturing the historical trend of how the route density changes with change in demand of the hub. The present solution also determines an upper limit for productivity and reduces a time required on negotiations every month for productivity estimations.

Hereinafter, exemplary embodiments of the present disclosure will be described in detail with reference to the accompanying drawings so that those skilled in the art can easily carry out the present disclosure.

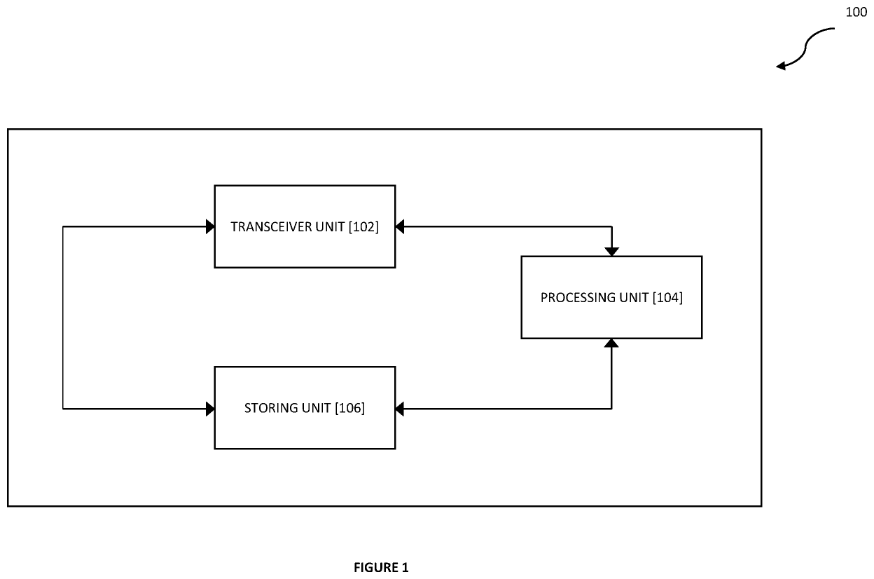

Referring to FIG. 1, an exemplary block diagram of a system [100] for predicting a last mile design productivity of a delivery hub for a target time period is shown. The system [100] comprises at least one transceiver unit [102], at least one processing unit [104] and at least one storage unit [106]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] may be present in a server device to implement the features of the present invention.

The system [100] is configured to predict a last mile design productivity of a delivery hub for a target time period, with the help of the interconnection between the components/units of the system [100].

The transceiver unit [102] of the system [100] is connected to the at least one processing unit [104] and at least one storage unit [106]. Also, the transceiver unit [102] may include but not limited to a transmitter to transmit data to one or more destinations and a receiver to receive data from one or more sources. Further, the transceiver unit [102] may include any other similar unit obvious to a person skilled in the art, to implement the features of the present invention. The transceiver unit [102] may convert data or information to signals and vice versa for the purpose of transmitting and receiving, respectively. Furthermore, in order to predict the last mile design productivity of the delivery hub for the target time period the transceiver unit [102] is configured to receive, an estimated load to be allocated to the delivery hub for the target time period. The estimated load to be allocated to the delivery hub for the target time period includes an estimated number of shipments to be delivered by the delivery hub in the target time period. The target time period may be any time period during which the last mile design productivity of the delivery hub is to be predicted. For example, a target time period may be a next month time period and an estimated load to be allocated to a delivery hub for the next month includes an estimated number of shipments to be delivered by the delivery hub in the next month.

Once, the estimated load to be allocated to the delivery hub for the target time period is received at the transceiver unit [102], it provides an indication of the same to the processing unit [104].

Further, the processing unit [104] is configured to predict an inter-shipment time for one or more last mile agents of the delivery hub based on the received estimated load. An inter-shipment time for a delivery agent includes an average time between 2 attempts/deliveries done by said delivery agent. More specifically, the processing unit [104] is configured to predict the inter-shipment time using a first sub-system. In an implementation the first sub-system is a linear regression model, but the same is not limited thereto and it may be any model that may be used to implement the features of the present invention. Also, the first sub-system is fine-tuned based on a first dataset and a second dataset. The first dataset comprises a data related to an inter-shipment distance parameter. An inter-shipment distance parameter for a delivery agent includes an average distance between 2 shipments allocated to said delivery agent. The data related to the inter-shipment distance parameter is determined using a second sub-system. The second sub-system provides a correlation between a load and density to determine the data related to the inter-shipment distance parameter. For instance: due to demand variability & allocation variation, a delivery boy/LMA may not get required load to demonstrate design productivity on a consistent basis. So in residential routes, when there is less load to deliver, the distance travelled by the delivery boy between 2 customers should increase as density is decreased and vice versa. In case of commercial routes, the distance travelled will always be low irrespective of the load given. Therefore, the second sub-system is configured to provide the correlation between the load and the density to determine the data related to the inter-shipment distance parameter. In an implementation the second sub-system is a GAM model, but the same is not limited thereto and it may be any model that may be used to implement the features of the present invention. Also, the second sub-system is fine-tuned based on a historical data associated with a planned load of the delivery hub. The historical data associated with the planned load of the delivery hub is retrieved based on the estimated load to be allocated to the delivery hub for the target time period. For example, if 1000 shipments (i.e., an estimated load) are required to be allocated to a delivery hub ‘A’ for a next month (i.e., for the target time period), in the given example the delivery hub A's historical data associated with a load of 1000 shipments is retrieved to fine-tune the second sub-system. The historical data associated with the planned load of the delivery hub is retrieved based on the estimated load to be allocated to the delivery hub for the target time period, to determine the inter-shipment distance parameter using similar load conditions.

Further, the second dataset is associated with a historical dataset of a plurality of delivery hubs, wherein each delivery hub of said plurality of delivery hubs is located in a same zone. The zone of said plurality of delivery hubs is same as that of the zone of the delivery hub for which the last mile design productivity is to be predicted. More particularly, in an implementation, if the delivery hub for which the last mile design productivity is to be predicted is associated with a 1^{st} zone (say North zone), then in the given implementation the second dataset is associated with a historical dataset of a plurality of delivery hubs located in the 1^{st} zone (i.e., North zone). Similarly, depending on the zone of the delivery hub for which the last mile design productivity is to be predicted, each delivery hub of the plurality of delivery hubs may be located in a North East West or South zone. The ZONE (North East West or South) is considered for clustering the delivery hubs as each zone is associated with cultural, demographic and geographical differences which plays a huge role in predicting the last mile design productivity.

Furthermore, the second dataset comprises at least a data related to at least one of a prepaid ratio parameter, a load allocation ratio parameter, a number of calls per shipment parameter, an idle time parameter and such other similar parameters required to predict the inter-shipment time. In an implementation the prepaid ratio parameter indicates a % of shipments where a payment is already done and in another implementation the prepaid ratio parameter indicates an expected % of shipments where a payment may be prepaid. Also, in an implementation the load allocation ratio parameter indicates a ratio of shipments allocated to a delivery boy and a delivery hub's average allocated shipments (indicating if the delivery boy is given less/more than expected shipments because of variability in demand allocation) and in another implementation the load allocation ratio parameter indicates a ratio of shipments allocated to a delivery boy and a delivery hub's average allocated shipments basis a plan such as a sale event etc. Further, in an implementation the number of calls per shipment parameter indicates an average number of calls made by a delivery boy to enquire per shipment and in another implementation the number of calls per shipment parameter indicates a number of calls as per a plan (such as during a sale event) that may be made by a delivery boy to enquire per shipment. Also, in an implementation the idle time parameter indicates an average idle time spent by a delivery agent in all idle attempts and in another implementation the idle time parameter indicates an average idle time that may be spent by a delivery agent in all idle attempts as per a plan (say basis a sale event).

Therefore, the first sub-system is fine-tuned based on the first dataset comprising of the data related to the inter-shipment distance parameter and the second dataset comprising at least of the data related to at least one of the prepaid ratio parameter, the load allocation ratio parameter, the number of calls per shipment parameter, the idle time parameter and such other similar parameters required to predict the inter-shipment time.

Further, the processing unit [104] of the system [100] is also configured to predict a productive on field time in a day for the one or more last mile agents of the delivery hub. The productive on field time in the day for each of the one or more last mile agents is a time provided to each of the one or more last mile agents in a day, for attempting a delivery of a set of shipments allocated to each of the one or more last mile agents. Also, the productive on field time in the day for each of the one or more last mile agents is predicted based on working hours in a day and a third dataset, wherein the third dataset comprises a data related to an average forward stem distance parameter and an average backward stem distance parameter, and the third dataset is a part of the second dataset. More specifically, the second dataset also comprises the third dataset consisting of the data related to the average forward stem distance parameter and the average backward stem distance parameter. The average forward stem distance parameter is associated with an average time required to reach to a first customer location from the delivery hub and the average backward stem distance parameter is associated with an average time required to reach to the delivery hub from a last customer location. Furthermore, a data related to the average time required to reach to the first customer location from the delivery hub and a data related to the average time required to reach to the delivery hub from the last customer location along with the working hours in a day are used to predict the productive on field time in the day for the one or more last mile agents of the delivery hub. In an implementation, in order to estimate a productive on-field time that a delivery boy gets in a day to attempt allocated shipments, working hours in a day and the third dataset is used. For instance: by design, the delivery boy is expected to work for 9 hours (540 mins) in a day, off which 90 mins are estimated for in hub activities and 60 mins lunch time. Off the remaining 390 mins the time required to reach the first customer location and last customer location back to hub is deducted to estimate the productive on-field time that the delivery boy gets in the day.

Further, once the inter-shipment time for the one or more last mile agents of the delivery hub and the productive on field time in a day for the one or more last mile agents of the delivery hub are predicted. The processing unit [104] is then configured to predict a total number of delivery attempts in a day for the one or more last mile agents of the delivery hub based on: the predicted inter-shipment time for the one or more last mile agents of the delivery hub, and the predicted productive on field time in a day for the one or more last mile agents of the delivery hub. In an implementation the total number of delivery attempts in a day may be predicted as below:

Total number of delivery attempts in a day=Predicted productive on field time in a day/Predicted inter-shipment time

After predicting the total number of delivery attempts in a day for the one or more last mile agents of the delivery hub, the processing unit [104] is further configured to predict a total number of successful deliveries in a day for the one or more last mile agents of the delivery hub based on: the predicted total number of delivery attempts in a day for the one or more last mile agents of the delivery hub, and an average hub conversion data. The average hub conversion data is determined based on the second dataset. More specifically, the second dataset also encompasses the average hub conversion data, wherein the average hub conversion data is a data associated with an average number of successful deliveries. In an implementation the average hub conversion data is multiplied with the predicted total number of delivery attempts in a day for the one or more last mile agents of the delivery hub to predict the total number of successful deliveries in a day for the one or more last mile agents of the delivery hub.

Once the predicted total number of successful deliveries in a day for the one or more last mile agents of the delivery hub are predicted, the processing unit [104] is then configured to predict the last mile design productivity of the delivery hub for the target time period based on the predicted total number of successful deliveries in a day for the one or more last mile agents of the delivery hub. In an implementation, the predicted total number of successful deliveries in a day for all last mile agents of the delivery hub indicates a predicted design productivity of the delivery hub. The predicted design productivity of the delivery hub has a number of use cases such as including but not limited to: identification of a gap in current design productivity and predicted design productivity to do manpower planning; identification of one or more delivery agents with a lower, average or higher productivity; and identification of one or more factors leading to the gap in the current design productivity and the predicted design productivity etc.

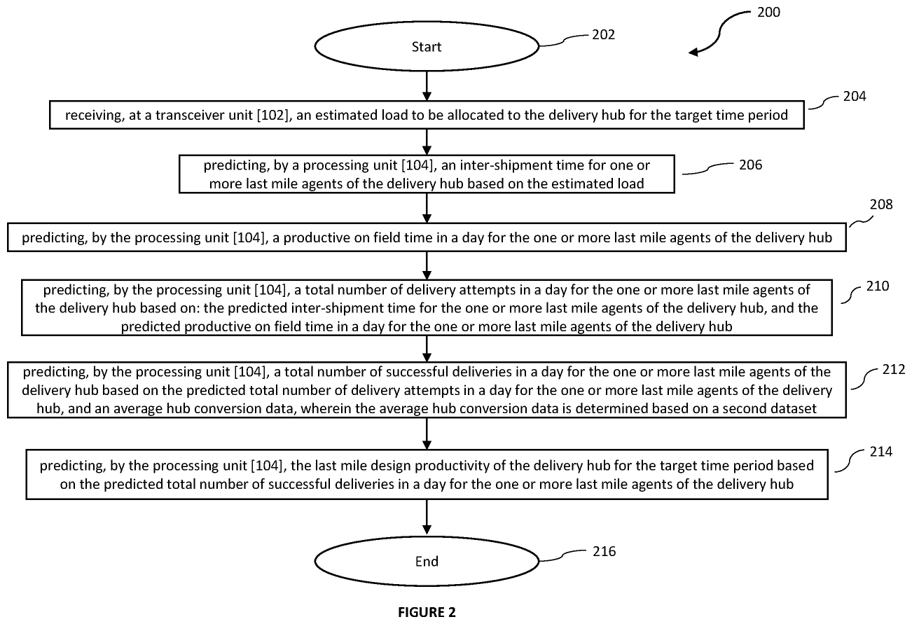

Referring to FIG. 2 an exemplary method flow diagram [200] for predicting a last mile design productivity of a delivery hub for a target time period is shown in accordance with exemplary embodiments of the present disclosure. In an implementation the method is performed by the system [100]. Further, in an implementation, the system [100] is connected to a server unit to implement the features of the present disclosure. Also, as shown in FIG. 2, for predicting the last mile design productivity of the delivery hub for the target time period, the method starts at step [202].

Thereafter, at step [204] the method comprises receiving, at a transceiver unit [102], an estimated load to be allocated to the delivery hub for the target time period. The estimated load to be allocated to the delivery hub for the target time period includes an estimated number of shipments to be delivered by the delivery hub in the target time period. The target time period may be any time period during which the last mile design productivity of the delivery hub is to be predicted. For example, a target time period may be a next three month time period and an estimated load to be allocated to a delivery hub for the three next month includes an estimated number of shipments to be delivered by the delivery hub in the next three month.

Once, the estimated load to be allocated to the delivery hub for the target time period is received at the transceiver unit [102], it provides an indication of the same to a processing unit [104]. Next, at step [206] the method comprises predicting, by the processing unit [104], an inter-shipment time for one or more last mile agents of the delivery hub based on the received estimated load. An inter-shipment time for a delivery agent includes an average time between 2 attempts/deliveries done by said delivery agent. More specifically, the method encompasses predicting the inter-shipment time using a first sub-system. In an implementation the first sub-system is a linear regression model, but the same is not limited thereto and it may be any model that may be used to implement the features of the present invention. Also, the first sub-system is fine-tuned based on a first dataset and a second dataset.

The first dataset comprises a data related to an inter-shipment distance parameter. An inter-shipment distance parameter for a delivery agent includes an average distance between 2 shipments allocated to said delivery agent. The data related to the inter-shipment distance parameter is determined using a second sub-system. The second sub-system provides a correlation between a load and density to determine the data related to the inter-shipment distance parameter. In an implementation the second sub-system is a GAM model, but the same is not limited thereto and it may be any model that may be used to implement the features of the present invention. Also, the second sub-system is fine-tuned based on a historical data associated with a planned load of the delivery hub. The historical data associated with the planned load of the delivery hub is retrieved based on the estimated load to be allocated to the delivery hub for the target time period. For example, if 5000 shipments (i.e., an estimated load) are required to be allocated to a delivery hub ‘Z’ for next two months (i.e., for the target time period), in the given example the delivery hub Z's historical data associated with a load of 5000 shipments is retrieved to fine-tune the second sub-system. The historical data associated with the planned load of the delivery hub is retrieved based on the estimated load to be allocated to the delivery hub for the target time period, to determine the inter-shipment distance parameter using similar load conditions.

Further, the second dataset is associated with a historical dataset of a plurality of delivery hubs, wherein each delivery hub of said plurality of delivery hubs is located in a same zone. The zone of said plurality of delivery hubs is same as that of the zone of the delivery hub for which the last mile design productivity is to be predicted. More particularly, in an implementation, if the delivery hub for which the last mile design productivity is to be predicted is associated with a 1^{st} zone (say West zone), then in the given implementation the second dataset is associated with a historical dataset of a plurality of delivery hubs located in the 1^{st} zone (i.e., West zone). Similarly, depending on the zone of the delivery hub for which the last mile design productivity is to be predicted, each delivery hub of the plurality of delivery hubs may be located in a North East West or South zone. The ZONE (North East West or South) is considered for clustering the delivery hubs as each zone is associated with cultural, demographic and geographical differences which plays a huge role in predicting the last mile design productivity.

Furthermore, the second dataset comprises at least a data related to at least one of a prepaid ratio parameter, a load allocation ratio parameter, a number of calls per shipment parameter, an idle time parameter and such other similar parameters required to predict the inter-shipment time. In an implementation the prepaid ratio parameter indicates a percentage of shipments where a payment is already done and in another implementation the prepaid ratio parameter indicates an expected percentage of shipments where a payment may be prepaid. Also, in an implementation the load allocation ratio parameter indicates a ratio of shipments allocated to a delivery boy and a delivery hub's average allocated shipments (indicating if the delivery boy is given less/more than expected shipments because of variability in demand allocation) and in another implementation the load allocation ratio parameter indicates a ratio of shipments allocated to a delivery boy and a delivery hub's average allocated shipments basis a plan such as a sale event etc. Further, in an implementation the number of calls per shipment parameter indicates an average number of calls made by a delivery boy to enquire per shipment and in another implementation the number of calls per shipment parameter indicates a number of calls as per a plan (such as during a sale event) that may be made by a delivery boy to enquire per shipment. Also, in an implementation the idle time parameter indicates an average idle time spent by a delivery agent in all idle attempts and in another implementation the idle time parameter indicates an average idle time that may be spent by a delivery agent in all idle attempts as per a plan (say basis a sale event).

Therefore, the method encompasses fine-tuning the first sub-system based on: the first dataset comprising of the data related to the inter-shipment distance parameter, and the second dataset comprising at least of the data related to at least one of the prepaid ratio parameter, the load allocation ratio parameter, the number of calls per shipment parameter, the idle time parameter and such other similar parameters required to predict the inter-shipment time.

Thereafter, the method at step [208] also comprises predicting, by the processing unit [104], a productive on field time in a day for the one or more last mile agents of the delivery hub. The productive on field time in the day for each of the one or more last mile agents is a time provided to each of the one or more last mile agents in a day, for attempting a delivery of a set of shipments allocated to each of the one or more last mile agents. Also, the productive on field time in the day for each of the one or more last mile agents is predicted based on working hours in a day and a third dataset, wherein the third dataset comprises a data related to an average forward stem distance parameter and an average backward stem distance parameter, and the third dataset is a part of the second dataset. More specifically, the second dataset also comprises the third dataset consisting of the data related to the average forward stem distance parameter and the average backward stem distance parameter. The average forward stem distance parameter is associated with an average time required to reach to a first customer location from the delivery hub and the average backward stem distance parameter is associated with an average time required to reach to the delivery hub from a last customer location. Furthermore, a data related to the average time required to reach to the first customer location from the delivery hub and a data related to the average time required to reach to the delivery hub from the last customer location along with the working hours in a day are used to predict the productive on field time in the day for the one or more last mile agents of the delivery hub. In an implementation, in order to estimate a productive on-field time that a delivery agent gets in a day to attempt allocated shipments, the method encompasses using working hours in a day and the third dataset. For instance: by design, the delivery agent is expected to work for 9 hours (540 mins) in a day, off which 90 mins are estimated for in hub activities and 60 mins lunch time. Off the remaining 390 mins the time required to reach the first customer location and last customer location back to hub is deducted to estimate the productive on-field time that the delivery agent gets in the day.

Further, once the inter-shipment time for the one or more last mile agents of the delivery hub and the productive on field time in a day for the one or more last mile agents of the delivery hub are predicted. Next at step [210] the method comprises predicting, by the processing unit [104], a total number of delivery attempts in a day for the one or more last mile agents of the delivery hub based on: the predicted inter-shipment time for the one or more last mile agents of the delivery hub, and the predicted productive on field time in a day for the one or more last mile agents of the delivery hub. In an implementation the total number of delivery attempts in a day may be predicted as below:

Total number of delivery attempts in a day=Predicted productive on field time in a day/Predicted inter-shipment time

After predicting the total number of delivery attempts in a day for the one or more last mile agents of the delivery hub, at step [212] the method comprises predicting, by the processing unit [104], a total number of successful deliveries in a day for the one or more last mile agents of the delivery hub based on: the predicted total number of delivery attempts in a day for the one or more last mile agents of the delivery hub, and an average hub conversion data. The average hub conversion data is determined based on the second dataset. More specifically, the second dataset also encompasses the average hub conversion data, wherein the average hub conversion data is a data associated with an average number of successful deliveries. In an implementation, the method encompasses multiplying the average hub conversion data with the predicted total number of delivery attempts in a day for the one or more last mile agents of the delivery hub, to predict the total number of successful deliveries in a day for the one or more last mile agents of the delivery hub.

Once the predicted total number of successful deliveries in a day for the one or more last mile agents of the delivery hub are predicted, thereafter at step [214] the method comprises predicting, by the processing unit [104], the last mile design productivity of the delivery hub for the target time period based on the predicted total number of successful deliveries in a day for the one or more last mile agents of the delivery hub. In an implementation, the predicted total number of successful deliveries in a day for all last mile agents of the delivery hub indicates a predicted design productivity of the delivery hub. The predicted design productivity of the delivery hub has a number of use cases such as including but not limited to: identification of a gap in current design productivity and predicted design productivity to do manpower planning; identification of one or more delivery agents with a lower, average or higher productivity; and identification of one or more factors leading to the gap in the current design productivity and the predicted design productivity etc.

After, predicting the last mile design productivity of the delivery hub for the target time period, the method terminates at step [216].

Therefore, the present invention provides a novel solution of predicting a last mile design productivity of a delivery hub for a target time period. The present invention provides a technical effect at least by providing a solution that can easily simulate impact on design productivity with changes in different input parameters in different situations. The present invention also provides a technical advancement over the currently known solutions by providing an efficient and effective automatic solution for last mile delivery boy design productivity prediction in a supply chain. Also, the present invention provides a technical advancement over the currently known solutions by estimating more realistic design productivity of each delivery hub. Furthermore, the present invention also provides a technical advancement over the currently known solutions by designing a productivity prediction based on various factors such as stem distance, COD-Prepaid ratio and call duration etc. The present solution is also technically advance over the currently known solutions as it provides an automatic solution that predicts more realistic design productivity for each delivery hub considering the type of routes the delivery hub services and capturing the historical trend of how the route density changes with change in demand of the hub. The present solution also determines an upper limit for productivity and reduces a time required on negotiations every month for productivity estimations.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We claim:

1. A method of predicting a last mile design productivity of a delivery hub for a target time period, the method comprising:
receiving, at a transceiver unit [102], an estimated load to be allocated to the delivery hub for the target time period;
predicting, by a processing unit [104], an inter-shipment time for one or more last mile agents of the delivery hub based on the estimated load;
predicting, by the processing unit [104], a productive on field time in a day for the one or more last mile agents of the delivery hub;
predicting, by the processing unit [104], a total number of delivery attempts in a day for the one or more last mile agents of the delivery hub based on:
the predicted inter-shipment time for the one or more last mile agents of the delivery hub, and
the predicted productive on field time in a day for the one or more last mile agents of the delivery hub;
predicting, by the processing unit [104], a total number of successful deliveries in a day for the one or more last mile agents of the delivery hub based on:
the predicted total number of delivery attempts in a day for the one or more last mile agents of the delivery hub, and
an average hub conversion data, wherein the average hub conversion data is determined based on a second dataset; and
predicting, by the processing unit [104], the last mile design productivity of the delivery hub for the target time period based on the predicted total number of successful deliveries in a day for the one or more last mile agents of the delivery hub.

2. The method as claimed in claim 1, wherein the estimated load to be allocated to the delivery hub for the target time period includes an estimated number of shipments to be delivered by the delivery hub in the target time period.

3. The method as claimed in claim 1, wherein the inter-shipment time is predicted using a first sub-system, wherein the first sub-system is fine-tuned based on a first dataset comprising of a data related to an inter-shipment distance parameter and the second dataset comprising at least of a data related to at least one of a prepaid ratio parameter, a load allocation ratio parameter, a number of calls per shipment parameter and an idle time parameter.

4. The method as claimed in claim 3, wherein the data related to the inter-shipment distance parameter is determined using a second sub-system, wherein the second sub-system is fine-tuned based on a historical data associated with a planned load of the delivery hub.

5. The method as claimed in claim 4, wherein the historical data associated with the planned load of the delivery hub is retrieved based on the estimated load to be allocated to the delivery hub for the target time period.

6. The method as claimed in claim 4, wherein the second sub-system provides a correlation between a load and density to determine the data related to the inter-shipment distance parameter.

7. The method as claimed in claim 3, wherein the second dataset is associated with a historical dataset of a plurality of delivery hubs, wherein each delivery hub of said plurality of delivery hubs is located in a same zone.

8. The method as claimed in claim 1, wherein the productive on field time in the day for each of the one or more last mile agents is predicted based on working hours in a day and a third dataset, wherein:
the third dataset comprises a data related to an average forward stem distance parameter and an average backward stem distance parameter, and
the third dataset is a part of the second dataset.

9. A system of predicting a last mile design productivity of a delivery hub for a target time period, the system comprising:
a transceiver unit [102], configured to:
receive, an estimated load to be allocated to the delivery hub for the target time period; and
a processing unit [104], configured to predict:
an inter-shipment time for one or more last mile agents of the delivery hub based on the estimated load,
a productive on field time in a day for the one or more last mile agents of the delivery hub,
a total number of delivery attempts in a day for the one or more last mile agents of the delivery hub based on:
the predicted inter-shipment time for the one or more last mile agents of the delivery hub, and
the predicted productive on field time in a day for the one or more last mile agents of the delivery hub,
a total number of successful deliveries in a day for the one or more last mile agents of the delivery hub based on:
the predicted total number of delivery attempts in a day for the one or more last mile agents of the delivery hub, and
an average hub conversion data, wherein the average hub conversion data is determined based on a second dataset, and
the last mile design productivity of the delivery hub for the target time period based on the predicted total number of successful deliveries in a day for the one or more last mile agents of the delivery hub.

10. The system as claimed in claim 9, wherein the estimated load to be allocated to the delivery hub for the target time period includes an estimated number of shipments to be delivered by the delivery hub in the target time period.

11. The system as claimed in claim 9, wherein the inter-shipment time is predicted using a first sub-system, wherein the first sub-system is fine-tuned based on a first dataset comprising of a data related to an inter-shipment distance parameter and the second dataset comprising at least of a data related to at least one of a prepaid ratio parameter, a load allocation ratio parameter, a number of calls per shipment parameter and an idle time parameter.

12. The system as claimed in claim 11, wherein the data related to the inter-shipment distance parameter is determined using a second sub-system, wherein the second sub-system is fine-tuned based on a historical data associated with a planned load of the delivery hub.

13. The system as claimed in claim 12, wherein the historical data associated with the planned load of the delivery hub is retrieved based on the estimated load to be allocated to the delivery hub for the target time period.

14. The system as claimed in claim 13, wherein the second sub-system provides a correlation between a load and density to determine the data related to the inter-shipment distance parameter.

15. The system as claimed in claim 11, wherein the second dataset is associated with a historical dataset of a plurality of delivery hubs, wherein each delivery hub of said plurality of delivery hubs is located in a same zone.

16. The system as claimed in claim 9, wherein the productive on field time in the day for each of the one or more last mile agents is predicted based on working hours in a day and a third dataset, wherein:
the third dataset comprises a data related to an average forward stem distance parameter and an average backward stem distance parameter, and
the third dataset is a part of the second dataset.
